(19) United States
(12) Patent Application Publication
(10) Pub. No.: US 2020/0223757 A1
(43) Pub. Date: Jul. 16, 2020

(54) METHOD FOR PRODUCING COMPLEX GEOMETRIC COMPONENTS CONTAINING CARBON OR SILICON CARBIDE

(71) Applicant: SGL CARBON SE, Wiesbaden (DE)

(72) Inventors: Oswin OETTINGER, Meitingen (DE); Dominik RIVOLA, Meitingen (DE); Philipp MODLMEIR, Meitingen (DE)

(73) Assignee: SGL CARBON SE, Wiesbaden (DE)

(21) Appl. No.: 16/648,378

(22) PCT Filed: Sep. 28, 2018
(86) PCT No.: PCT/EP2018/076544

§ 371 Date: Mar. 18, 2020

(30) Foreign Application Priority Data
Sep. 28, 2017 (DE) 10 2017 217 358.0

(51) Int. Cl. C04B 35/565; C04B 35/52; C04B 35/532

(52) U.S. Cl. CPC C04B 35/565; C04B 35/522; C04B 35/532; C04B 2235/9607; C04B 2235/77; C04B 2235/6026; C04B 2235/614; C04B 2235/608

(57) ABSTRACT

The present disclosure relates to a method for producing a complex geometric component containing carbon or silicon carbide, to the component produced by said method and to the use thereof.

The present invention relates to a method for producing a complex geometric component containing carbon or silicon carbide, to the component produced by said method and to the use thereof.

Complex geometric components containing carbon, graphite or silicon carbide can be produced using an additive manufacturing process, the 3D-printing process. When producing these components, a post-compression with resin (WO 2017/089494, DE 10 2015 223 238) or with pitch (WO 2015/038260) is carried out. In the case of producing a component containing silicon carbide, the resin, with which the step of post-compression takes place, serves for example only as a carbon donor. In the case of such a component, there are no special requirements in terms of strength. A component containing carbon or graphite and having higher strengths can be produced, in which first a post-compression with for example phenolic resin takes place, with subsequent graphitising and then a further impregnation with a resin. This last impregnation increases the strength of the component; the impregnation with the phenolic resin and graphitising ensure an electrically conductive network in the component. The operating temperature of this component is given by the last resin impregnation. If, on the other hand, a post-compression with pitch is carried out, this is made liquid again during pyrolysis or carbonising, such that a bleeding (running out) of the pitch from the carbon body produced by 3D printing takes place. Furthermore, due to gravity, the pitch will sink. As a result, the component based on carbon or graphite is inhomogeneous and has distinct density gradients from top to bottom. Bleeding also significantly changes the outer contour of the structure, as a result of which post-processing is required. Furthermore, pitch is considered to be carcinogenic and can therefore only be further processed in compliance with certain safety requirements.

The object of the present invention is therefore to provide a method for producing a complex geometric component containing carbon or silicon carbide, with which a largely homogeneous component having good mechanical properties and high end contour proximity can be produced.

Within the scope of the present invention, this object is achieved by a method for producing a complex geometric component containing carbon or silicon carbide comprising the following steps:
a) providing a green body based on carbon or silicon carbide, which has been produced by means of a 3D-printing process,
b) post-compression of the green body by means of chemical vapour infiltration.

According to the invention, it was recognised that the pores of the green body based on carbon or silicon are filled more evenly when using chemical vapour infiltration (CVI), which leads to a higher homogeneity and improved mechanical properties with high end contour proximity of the produced structure.

The green body based on carbon or silicon carbide in step a) is produced by means of a 3D-printing process. Such a green body can be produced in accordance with the method described in WO 2017/089494.

In this method, a powdery composition having a granulation (d50) between 3 μm and 500 μm, preferably between 50 μm and 350 μm, more preferably between 100 μm and 250 μm, comprising at least 50 wt. % coke, preferably at least 80 wt. %, more preferably at least 90 wt. % and most preferably at least 95 wt. % coke, and a liquid binder are provided. Thereafter, a flat deposit of a layer of the powdery composition takes place, followed by a local deposit of droplets of the liquid binder onto said layer. These steps are repeated until the desired shape of the component is produced, the individual steps being adapted to the desired shape of the component. Thereafter, an at least partial curing or drying of the binder takes place, wherein the green body having the desired shape of the component is created. The above-mentioned powdery composition can be either a powder of primary particles or a granulate. The term “d50” is understood to mean that 50% of the particles are smaller than the specified value. The d50 value was determined using the laser granulometric method (ISO 13320), wherein a measuring instrument from Sympatec GmbH with associated evaluation software was used.

Obtaining a green body having the desired shape of the component is understood to mean the following Immediately after curing or drying of the binder, the green body is still surrounded by a bulk powder made of loose particles of the powdery composition. The green body must therefore be removed from the bulk powder or separated from the loose, non-solidified particles. In the literature on 3D printing this is also called “unpacking” the printed component. Unpacking of the green body can be followed by a (fine) cleaning of said body in order to remove adhering particle residues. Unpacking can be performed, for example, by suction of the loose particles with a powerful vacuum cleaner. However, the type of unpacking is not particularly limited, and all known methods can be used.

Although the type of coke used is not particularly limited, according to a preferred embodiment of the present invention, the green body was produced in step a) using coke, preferably selected from the group consisting of acetylene coke, flexicoke, fluid coke, petroleum coke, shot coke, coal tar pitch coke, coke of carbonised ion exchange beads and any mixtures thereof, more preferably selected from the group consisting of acetylene coke, flexicoke, fluid coke, shot coke, coke from carbonised ion exchange beads and any mixtures thereof. The advantage of using these cokes is that they have a coke shape that is as round as possible, wherein the round shape leads to good pourability and thus to a smooth 3D-printing process. Furthermore, a coke shape that is as round as possible contributes to an increased breaking strength of the ceramic component. The reason for this probably lies in the round and partly onion skin-like structure of these coke varieties. These cokes can be used as so-called green coke, as calcined or carbonised coke or as graphitised coke, preferably as green coke. Green coke is a coke that still contains volatile components. These volatile components are virtually non-existent in calcined or carbonised coke, wherein this coke undergoes a temperature treatment of typically 700° C. to 1400° C. The terms “calcined” or “carbonised” are understood as synonyms. Graphitised coke is obtained by treating the coke at a temperature that is normally greater than 2000° C. to 3000° C.

In the production of the green body, it may be advantageous to add a liquid activator, such as a liquid sulphuric acid activator, to the coke. By using such an activator, the curing time and the temperature required for curing the binder can be reduced on the one hand, and the dust development of the powdery composition is reduced on the other. Advantageously, the amount of activator is 0.05 wt. % to 3.0 wt. %, more preferably 0.1 wt. % to 1.0 wt. %, based on the total weight of coke and activator. If more than 3.0 wt. % based on the total weight of activator and coke is used, the powdery composition will stick together and pourability will be reduced; if less than 0.05 wt. % based on the total weight of coke and activator is used, the amount of activator which can react with the binder, more precisely the resin component of the binder, is too low to achieve the desired advantages above.

The selection of the binder used to produce the 3D-printed green body is not particularly limited. Suitable binders are, for example, phenolic resins, furan resins, polyimides, cellulose, starch, sugar, silicates, silicon-containing polymers, pitch, polyacrylonitrile (PAN) or any mixtures thereof. Solutions of the aforementioned binders are also included herein. Basically, the binders should be such that stable bodies can be obtained after carbonising. The binder should have either a sufficiently high carbon yield or an Si-containing inorganic yield when using Si organic binders after pyrolysis. When choosing thermoplastic binders such as pitch, it may be necessary to carbonise the entire powder bed in order to decompose it and thus ultimately to crosslink it. The same applies to PAN. The powder bed without binder additive acts as a support for the component, while the thermoplastic binder such as pitch or PAN is carbonised. In addition, the powder bed acts advantageously as oxidation protection for the printed green body during the subsequent carbonising treatment.

As binders, phenolic resins, furan resins or polyimides represent resins and polymers having a comparatively high carbon yield. They belong to the class of binders that are converted into a non-melting binder system by curing.

However, cellulose, starch or sugar, preferably present as a solution, can also be used as binders. These binders only need to be dried, which is inexpensive.

The use of silicates or silicon-containing polymers as binders, preferably present as a solution, has the advantage that these binders also only need to be cured. They form SiC by themselves when carbonising.

Preferably, the proportion of the binder in the green body is 1.0 to 35.0 wt. %, preferably 1.0 to 10.0 wt. % and most preferably 1.5 to 5.0 wt. %, based on the total weight of the green body.

If, on the other hand, silicon carbide is used in step a) for 3D printing, SiC powder is used having a granulation (d50) between 50 μm and 500 μm, preferably between 60 μm and 350 μm, more preferably between 70 μm and 300 μm, particularly preferably between 75 μm and 200 μm, and a liquid binder. The binders are the same binders that are used for 3D printing of coke. The SiC is used in the form of a powder, which preferably has a granulation (d50) between 50 μm and 500 μm, preferably between 60 μm and 350 μm, more preferably between 70 μm and 300 μm, particularly preferably between 75 μm and 200 μm. For determining the d50 value, the laser granulometric method (ISO 13320) was also used here, wherein a measuring instrument from Sympatec GmbH with associated evaluation software was used. Methods for chemical vapour infiltration (CVI), in particular of carbon, are described in DE 19646094 or WO 2013/104685. As a CVI method, for example, a method can be used that works in an isothermal and isobaric manner (conventional CVI method) as described in DE 19646094, or a method can be used in which high pressures and a short dwell time of the gas take place, the “rapid CVI method” according to WO 2013/104685.

Advantageously, in step b) of the method according to the invention, the conventional CVI method or the rapid CVI method is used. It is further preferred that, in the method according to the invention, chemical vapour infiltration according to step b) is carried out using a carbon-containing gas, preferably natural gas, methane gas or propane gas, more preferably natural gas.

In a further preferred embodiment of the present invention, chemical vapour infiltration according to step b) of the method is carried out at a temperature between 950° C. and 1400° C., preferably at a temperature between 1100° C. and 1300° C.

In yet another preferred embodiment of the present invention, the chemical vapour infiltration according to step b) is carried out at a pressure of 5 mbar to 50 mbar, preferably at a pressure of 15 mbar to 30 mbar.

Advantageously, in the inventive method in step b) a gassing time of 100 to 400 hours, preferably of 150 to 350 hours is carried out.

Within the scope of the invention, it is also possible that after step a) of the method an impregnation of the green body takes place using an impregnation agent selected from the group consisting of a phenolic resin, a furan resin, a sugar solution, a cellulose solution, a starch solution or pitch, preferably a phenolic resin, a furan resin or pitch. This impregnation step increases the density of the green body and the green body gains more strength.

Preferably, a carbonising step is carried out after said impregnation step of the green body. The term “carbonising” means the thermal conversion of the impregnation agent, which the green body contains, to carbon. Carbonising can be achieved by heating to temperatures in a range from 500° C. to 1100° C., preferably from 800° C. to 1000° C., under a protective gas atmosphere (e.g. under an argon or nitrogen atmosphere) with subsequent holding time.

According to yet another embodiment of the present invention, the above-mentioned impregnation step and the carbonising step can be carried out more than once.

According to yet another embodiment of the present invention, after step b) of the method a graphitising step can also take place, wherein said graphitising step is carried out in a temperature range of 2000° C. to 3000° C., preferably in a temperature range of 2400° C. to 2800° C. This also includes that before step b) the above-described impregnation step(s) and carbonising step(s) is/are carried out.

A further subject of the present invention is a complex geometric component, which has been produced according to the inventive method.

The component according to the invention may comprise carbon, graphite or silicon carbide.

The component according to the invention comprising carbon has a density of more than 1.3 g/cm³ and the component according to the invention comprising graphite has a density of greater than 1.4 g/cm³, preferably of greater than 1.5 g/cm³.

Furthermore, the component according to the invention comprising graphite has a thermal conductivity of more than 30 W/m·K, preferably of more than 40 W/m·K. The thermal conductivity was determined according to DIN 51908. This component according to the invention also has a flexural strength of more than 10 MPa, preferably of more than 15 MPa. The strength was determined according to the 3-point bending method according to DIN 51902.

A further subject of the present invention is the use of the components according to the invention for chemical apparatus construction, as a casting core or as a casting mould, preferably as a casting mould having undercuts or cooling sections, or as a hollow body.

In the following, the present invention is further described on the basis of these explanatory but not limiting examples with reference to the drawings.

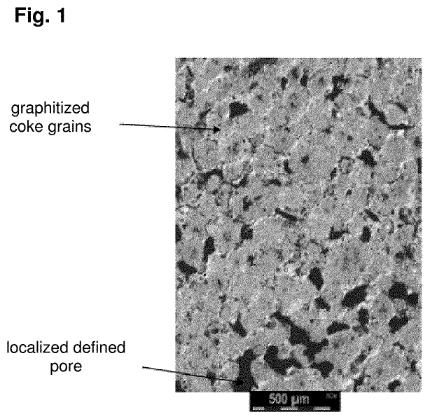

FIG. 1 shows a microsection of a component according to the invention comprising graphite.

### EXAMPLES

### Inventive Examples 1 and 2

Coke powder of the green flexicoke sifted down with 0.1 mm and sifted upwards with 0.4 mm was initially mixed with 0.35 wt. % of a sulphuric acid liquid activator for phenolic resin, based on the total weight of coke and activator, and processed using a 3D-printing powder bed machine. A scraper unit places a thin coke powder layer (approx. 0.26 mm height) on a flat powder bed and a kind of inkjet printing unit prints an alcoholic phenolic resin solution onto the coke bed according to the desired component geometry. Subsequently, the printing table is lowered by the layer thickness and a layer of coke is again applied and phenolic resin is reprinted locally. The repeated procedure resulted in the construction of cuboid test specimens having dimensions of 120 mm (length)×20 mm (width)×20 mm (height). After the printing process, the powder bed is placed in an oven preheated to 140° C. and kept there for about 6 hours, so that the phenolic resin binder is cured and a dimensionally stable green body is created. The density of the green body after curing of the binder is 0.95 g/cm³. Density was determined geometrically (by weighing and determining geometry). Subsequently, the green body was subjected to a furan resin immersive impregnation and likewise cured at 140° C. The resin consisted of 10 parts of furfuryl alcohol and one part of malic acid anhydride as a curing agent. Subsequently, the green bodies were slowly heated to 900° C. under a nitrogen atmosphere and carbonised thereby. The density was thus increased to 1.1 g/cm³. The open porosity was about 30%. This measure made the handling of the body more robust. Subsequently, the body was subjected to vapour infiltration with a natural gas/argon mixture. The process temperature was 1200° C., the process pressure was at 50 mbar pressure and the gassing time was 300 hours. The final density of the body was 1.37 g/cm³ and the body had an open porosity of about 12%. Some of the samples were physically and mechanically characterised (examples 1.1); other samples were heated to 2600° C. in a graphitising furnace. These samples were likewise subjected to analogous characterisation (example 1.2). The graphitising treatment resulted in a small geometrical shrinkage, so that the final density of the specimens increased to 1.51 g/cm³. The properties of the specimens are summarised in Tables 1 and 2 following to the comparative example.

### Comparative Example 1-Liquid Resin Impregnation

Some of the 3D bodies from the above examples were subjected to a liquid resin post-compression after furan resin impregnation and carbonising instead of the CVI post-compression. Phenolic resin with the type designation 9905 DL was used in this case. The bodies were initially impregnated with the phenolic resin under vacuum pressure and after curing at 140° C., they were carbonised under a nitrogen atmosphere at 900° C. After the first liquid resin post-compression with phenolic resin and subsequent carbonising, the density was 1.28 g/cm³ and the open porosity was about 22%. The post-compression process with the phenolic resin was repeated twice more, so that at the end the carbonised bodies had a density of 1.39 g/cm³. The open porosity was 11%. Some of the samples were characterised in the same way as example 1.1 (see table, example 2.1). Other samples were graphitised at 2000° C. and finally characterised analogously to example 1.2 (see table, examples 2.2). In addition, a graphitised sample was subjected to a microscopic examination.

Tables 1 and 2 below summarise the properties of the bodies from example 1 and 2 for the carbonised state (example 1.1 and example 2.1) and for the graphitised state (example 1.2 and example 2.2):

TABLE 1
Physical and mechanical properties of the carbonised bodies

| | Density | Flexural strength | Thermal conductivity |
|---|---|---|---|
| | [g/cm3] | [MPa] | [W/m · K] |
| Non-inventive | 1.39 | 11 | 1.5 |
| example 2.1 | | | |
| Inventive | 1.37 | 22 | 6 |
| example 1.1 | | | |

As shown in Table 1, 3D-printed carbon bodies can be post-compressed with carbon both by means of liquid resin and via the gas phase, so that densities of approx. 1.4 g/cm³ can be achieved. The flexural strength level of the samples with vapour deposition is thereby significantly improved, which indicates a better connection of the pyrocarbon to the coke grains by means of vapour deposition.

Said improved connection of the pyrocarbon to the coke grains by means of the vapour deposition is even more noticeable after the graphitising treatment. While the graphitised carbon having resin as the starting substance shrinks away from the coke grain and a poor connection is thus established between the matrix and the coke grains, in the pyrocarbon coating via CVI an internal contact with the coke grains is formed and therefore relatively good mechanical properties. The good connection of CVI carbon to the coke grains is confirmed by the microsection according to FIG. 1.

For the comparison of properties of the component according to the invention comprising graphite, Sigrafine® MKUN, a vibration-compressed graphite, commercially available from SGL Carbon GmbH, was additionally used.

The property comparison of the component according to the invention comprising graphite with the graphite conventionally produced by means of vibration compression shows that an equivalent material property profile can be generated by means of the 3D-printing and CVI compression process steps. Despite the lower density of the component according to the invention, even slightly improved bending properties could be achieved. One reason could be the slightly fine structure of the component according to the invention with max. grain of 0.4 mm compared to the comparative graphite with max. grain of 0.8 mm

TABLE 2
Physical and mechanical properties of graphitised
bodies compared to Sigrafine ® MKUN

| | Density | Flexural strength | Thermal conductivity |
|---|---|---|---|
| | [g/cm³] | [MPa] | [W/m · K] |
| Non-inventive | 1.56 | 4 | 40 |
| example 2.2 | | | |
| Inventive | 1.51 | 16 | 45 |
| example 1.2 | | | |
| Sigrafine MKUN | 1.66 | 12 | 120 |

In addition, a different coke was used in the production of Sigrafine® MKUN, which graphitises more easily. This may explain the slightly different values at specific electrical resistance (example 1.2: 15 μOHM*m, Sigrafine MKUN: 15 μOHM*m), the differences in thermal conductivity and also the slight difference in thermal expansion behaviour (room temperature/200° C.; example 1.2: 4.0 μm/(mK), Sigrafine MKUN: 3.0 μm/(mK).

1-15. (canceled)

16. A method for producing a complex geometric component containing carbon or silicon carbide, comprising the following steps:
a) providing a green body based on carbon or silicon carbide, which has been produced by means of a 3D-printing process, and
b) post-compressing the green body by means of chemical vapour infiltration.

17. The method according to claim 16, wherein the green body containing carbon according to step a) has been produced using coke.

18. The method according to claim 17, wherein the coke is a green coke, a carbonised coke or a graphitised coke.

19. The method according to claim 16, wherein the chemical vapour infiltration according to step b) is carried out using a carbon-containing gas.

20. The method according to claim 16, wherein the chemical vapour infiltration according to step b) is carried out at a temperature between 950° C. and 1400° C.

21. The method according to claim 16, wherein the chemical vapour infiltration according to step b) is carried out at a pressure of 5 mbar to 50 mbar.

22. The method according to claim 16, wherein the chemical vapour infiltration according to step b) is carried out with a gassing time of 100 to 400 hours.

23. The method according to claim 16, wherein after step a) an impregnation of the green body takes place by means of an impregnation agent selected from the group consisting of a phenolic resin, a furan resin, a sugar solution, a cellulose solution, a starch solution or a pitch.

24. The method according to claim 23, wherein after impregnation a carbonising step of the green body takes place.

25. The method according to claim 16, wherein after step b) a graphitising step is carried out.

26. A component produced according to claim 16 comprising carbon, graphite or silicon carbide.

27. The component according to claim 26, wherein the component comprising carbon has a density of more than 1.3 g/cm³, and the component comprising graphite has a density of greater than 1.4 g/cm³.

28. The component according to claim 26, wherein the component comprising graphite has a thermal conductivity of more than 30 W/m·K.

29. The component according to claim 26, wherein the component comprising graphite has a flexural strength of more than 10 MPA.

30. Use of a component according to claim 26 as components for chemical apparatus construction, as a casting core, as a casting mould or as a hollow body.
